(19) United States
(12) Patent Application Publication
(10) Pub. No.: US 2026/0348198 A1
(43) Pub. Date: Nov. 5, 2026

(54) ADJUSTABLE CHILD-PROOF DOOR LOCK WITH GAP-PREVENTION BUTTON

(71) Applicant: Zhejiang Jike Industry & Trade Co., LTD., Jinhua (CN)

(72) Inventor: Zhong Jin, Jinhua (CN)

(21) Appl. No.: 19/698,903

(22) Filed: Jun. 5, 2026

(51) Int. Cl. E05B 65/00; E05C 19/00

(52) U.S. Cl. CPC E05B 65/0014; E05C 19/003

(57) ABSTRACT

A child-proof locking apparatus for preventing unauthorized opening of a closable element includes an elongate body member, a first attachment portion pivotably coupled to a first end of the body member, and a second attachment portion pivotably coupled to a second end. The attachment portions are rotatable to adjust an effective length of the apparatus to accommodate different door dimensions. A roller rotatably disposed within the body member is rotatable to selectively advance a protrusion from a rear face at a plurality of discrete positions. When installed, the door-contacting surfaces of the attachment portions and the distal end of the protrusion define three coplanar contact points that bear against the closable element, thereby holding the closable element flush against an adjacent structure and preventing formation of a gap therebetween. A safety lock selectively restricts roller rotation.

### FIELD OF THE INVENTION

The present invention relates to child safety devices, and more particularly to an adjustable locking apparatus for preventing unauthorized opening of closable elements such as appliance doors and cabinet doors by young children.

### BACKGROUND OF THE INVENTION

Child safety is a paramount concern in the modern household. Young children are naturally curious and instinctively attempt to open cabinet doors, refrigerator doors, drawers, and other closable elements, thereby exposing themselves to potentially dangerous items such as medications, chemicals, sharp objects, and food items unsafe for young children. To address this hazard, a variety of child-proof locking devices have been developed and made commercially available for securing such closable elements against unauthorized opening by children.

Existing child-proof locking devices for appliance doors and cabinet doors generally comprise an elongate body or strap that is attached to the exterior surface of one or both doors by adhesive pads, clips, or other fastening means, and that spans across the door surfaces to mechanically resist opening forces applied by a child. Other known devices comprise generally U-shaped or similar structures that engage the handles of adjacent side-by-side doors to prevent the doors from being pulled open. Still other devices are mounted internally within the door structure and operate through the existing door hardware to resist rotation or displacement of the door.

While such prior art devices provide a degree of resistance to unauthorized door opening, they all share a fundamental and unresolved deficiency: none of these devices is capable of holding the closable element in a fully flush, zero-gap closed position against its door frame or adjacent door surface. Because existing exterior locking devices are attached at discrete points on the door surface, and because the body of the locking apparatus itself has a physical thickness that stands proud of the door surface, the door is not held firmly and flatly against its adjacent structure when the lock is installed. A gap inevitably remains between the closable element and the adjacent door frame or adjacent door even when the locking apparatus is in the locked position.

This residual gap presents serious and well-recognized safety hazards. A young child can insert fingers into the gap between the door and the door frame, risking painful pinching injuries. Furthermore, a child may exploit the gap to apply leveraged force to the door, potentially defeating the locking apparatus entirely. Despite the widespread recognition of this deficiency in the art, no prior art exterior child-proof locking device has successfully addressed the problem of maintaining the closable element in a fully flush, tightly closed position while remaining externally mountable, tool-free, and adjustable for use on closable elements of varying dimensions.

Accordingly, there remains a long-felt and unmet need in the art for a child-proof locking apparatus that positively holds a closable element flush and tight against its adjacent structure, eliminates any residual gap between the closable element and the door frame or adjacent door upon installation, and is adjustable to accommodate closable elements of varying dimensions without requiring permanent installation or the use of tools.

### SUMMARY OF THE INVENTION

The terms "the invention," "this invention," and "the present invention" as used herein are intended to refer broadly to all of the subject matter described in this patent application and the claims below. Embodiments of the invention are defined by the claims, not this summary. Nothing in this summary is intended to limit the scope of any claim.

In one aspect, a child-proof locking apparatus is provided for preventing unauthorized opening of a closable element, such as a door, cabinet, drawer, or similar structure, by a child.

In one embodiment, the apparatus comprises an elongate body member having a user-facing front face and a door-facing rear face. A first attachment portion is pivotably coupled to a first end of the body member and is rotatable relative to the body member, the first attachment portion having a door-contacting surface configured to be secured to a surface of the closable element. A second attachment portion is pivotably coupled to a second end of the body member, opposite the first end, and is rotatable relative to the body member, the second attachment portion also having a door-contacting surface configured to be secured to the surface of the closable element.

In one embodiment, rotation of the first attachment portion and the second attachment portion relative to the body member adjusts an effective length of the apparatus, enabling the apparatus to accommodate closable elements of varying dimensions and configurations.

In one embodiment, the apparatus further comprises a button movably disposed within the body member and accessible from the front face. The button is depressible inward from the front face and includes a protrusion extending from the rear face of the body member. The protrusion is selectively positionable at a plurality of discrete positions, each corresponding to a different protrusion length extending from the rear face.

In one embodiment, when the apparatus is secured to the closable element, the door-contacting surface of the first attachment portion, the door-contacting surface of the second attachment portion, and a distal end of the protrusion are coplanar and collectively bear against the surface of the closable element at three contact points lying in a common plane. This three-point coplanar contact configuration holds the closable element flush against an adjacent structure and prevents the closable element from opening any gap.

In one embodiment, each of the first attachment portion and the second attachment portion is rotatable relative to the body member through at least 180 degrees, such that each attachment portion may face an opposite side of the closable element, thereby selectively increasing or decreasing the effective length of the apparatus.

Embodiments may further include one or more of the following aspects, alone or in any combination: the apparatus secured to one or more surfaces of the closable element using adhesive, mechanical fasteners, or other attachment means; the button actuatable to selectively extend or retract the protrusion among the plurality of discrete positions; closable elements including but not limited to doors, cabinet doors, drawers, sliding panels, gates, and hinged enclosures; and attachment portions rotatable to any angle that achieves flush contact with the surface of the closable element.

### BRIEF DESCRIPTION OF THE DRAWINGS

FIG. 1 is a front elevational view of a child-proof locking apparatus 100 configured to prevent opening of a closable element, such as a refrigerator door or cabinet door, by a child.

FIG. 2 is a rear elevational view of the child-proof locking apparatus 100 of FIG. 1, illustrating a door-facing rear face configured to be positioned adjacent a surface of the closable element.

FIG. 3 is an exploded view of the child-proof locking apparatus showing the body member divided into upper, middle, and lower portions and the internal safety lock and roller mechanism.

FIG. 4 is a view of the child-proof locking apparatus installed across two door panels, illustrating different protrusion settings of the roller relative to the gap between the doors.

FIG. 5 is a view of the child-proof locking apparatus installed across a first door panel and a second door panel of a closable element, illustrating the attachment of the apparatus to two separate door panels to resist opening of the closable element.

### DETAILED DESCRIPTION

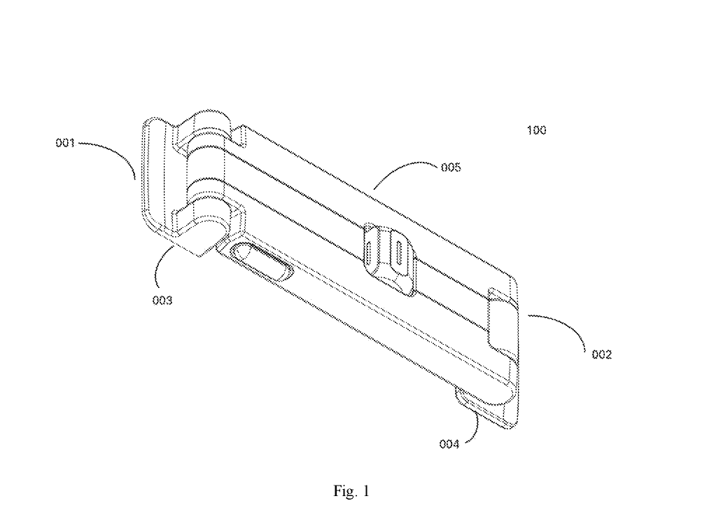

FIG. 1 is a front elevational view of the child-proof locking apparatus 100. The apparatus 100 is a child-proof locking device configured to prevent a child from opening a closable element, including, without limitation, a refrigerator door or a cabinet door. FIG. 1 illustrates the user-facing front face of the apparatus 100 in an assembled configuration.

Referring now to FIG. 1, a child-proof locking apparatus is illustrated in an assembled configuration. The apparatus includes an elongate body member 005. The body member 005 extends longitudinally between a first end and a second end.

A first attachment portion 001 is pivotably coupled to the first end of the body member 005 and is rotatable relative to the body member 005. A second attachment portion 002 is pivotably coupled to the second end of the body member 005 and is rotatable relative to the body member 005. As the first attachment portion 001 and the second attachment portion 002 are rotated relative to the body member 005, the effective length of the apparatus as measured between the outermost ends of the first attachment portion 001 and the second attachment portion 002 changes accordingly. In one embodiment, the first attachment portion 001 and the second attachment portion 002 may each be rotated up to approximately 180 degrees toward the user-facing front face of the body member 005, placing the apparatus in a minimum-length configuration. This adjustability allows the apparatus to accommodate closable elements of different dimensions, including, without limitation, refrigerator doors and cabinet doors having varying gap dimensions relative to an adjacent structure.

The first attachment portion 001 includes a door-contacting surface 003. The second attachment portion 002 includes a door-contacting surface 004. The door-contacting surface 003 and the door-contacting surface 004 are each configured to be secured to a surface of the closable element. In some embodiments, the door-contacting surface 003 and the door-contacting surface 004 are secured to the closable element surface by an adhesive. Suitable adhesives include, without limitation, a strong-bonding adhesive, a double-sided adhesive tape, or a removable adhesive that permits repositioning or removal of the apparatus without damaging the closable element surface.

In one embodiment, the apparatus is fabricated from a plastic material. In another embodiment, the apparatus is fabricated from a metallic material. In yet other embodiments, the apparatus is fabricated from a combination of plastic and metallic components.

The apparatus finds utility across a wide range of applications in residential, commercial, and institutional settings where preventing unauthorized opening of a closable element by a child is desirable. In one embodiment, the apparatus is applied to a double-door refrigerator, wherein the door-contacting surface 003 is secured to a surface of a first refrigerator door panel and the door-contacting surface 004 is secured to a surface of a second refrigerator door panel, preventing a child from pulling the refrigerator doors apart. In another embodiment, the apparatus is applied to a kitchen cabinet having two adjacent cabinet doors, wherein the door-contacting surface 003 and the door-contacting surface 004 are secured to the respective cabinet door panels to prevent a child from accessing cabinet contents such as cleaning supplies, sharp utensils, or medications. In yet another embodiment, the apparatus is applied to a pantry cabinet, a bathroom vanity cabinet, or a storage closet having double doors, wherein the apparatus spans the gap between the two door panels to prevent unauthorized access by a child. In a further embodiment, the apparatus is applied to a pair of sliding doors or bi-fold doors, wherein the door-contacting surface 003 and the door-contacting surface 004 are each secured to a respective door panel to restrain relative movement between the panels. In still another embodiment, the apparatus is applied to oven doors, dishwasher doors, or other household appliance doors to prevent a child from opening the appliance during or after operation.

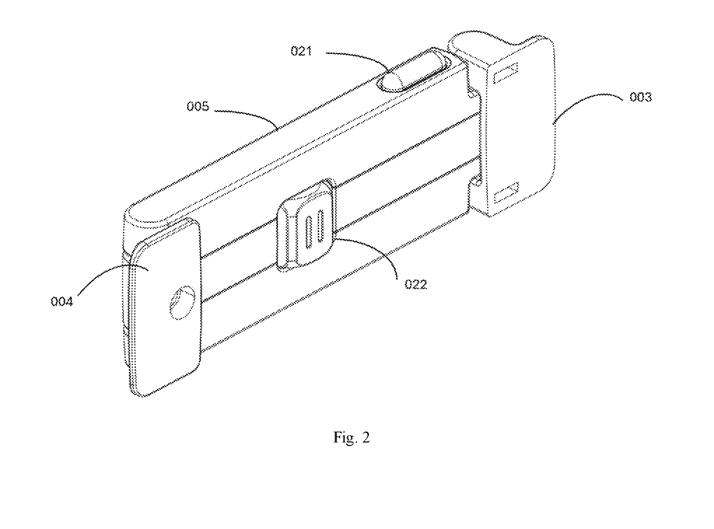

FIG. 2 is a rear elevational view of the child-proof locking apparatus 100, illustrating the door-facing rear face of the apparatus 100. The rear face of the apparatus 100 is the face that, in use, is oriented toward the surface of the closable element.

Referring now to FIG. 2, a rear elevational view of the child-proof locking apparatus 100 is shown. FIG. 2 illustrates a door-facing rear face of the apparatus 100, which, in use, is oriented toward a surface of a closable element such as a refrigerator door or cabinet door.

The apparatus 100 includes the body member 005 extending between the first attachment portion 001 and the second attachment portion 002. The door-contacting surface 003 of the first attachment portion 001 and the door-contacting surface 004 of the second attachment portion 002 are visible in FIG. 2 and are configured to be secured to respective door panels of the closable element so that the apparatus 100 bridges across a gap between the door panels and resists opening of the doors by a child.

Disposed on the rear face of the body member 005 is a roller 022. The roller 022 is mounted to the body member 005 so as to be rotatable about a roller axis. As the roller 022 is rotated about the roller axis, a protruding portion of the roller 022 assumes different angular positions relative to the rear face of the body member 005. In different rotational positions, the protruding portion of the roller 022 presents different effective protrusion heights extending toward the surface of the closable element. In some embodiments, the roller 022 is configured such that, in a selected rotational position, the protruding portion of the roller 022 extends to a height that positions a distal end of the protruding portion substantially in a common plane with the door-contacting surface 003 and the door-contacting surface 004 when the apparatus 100 is installed. In this configuration, the body member 005 and the roller 022 cooperate with the first attachment portion 001 and the second attachment portion 002 to bear against the surface of the closable element at multiple contact locations and hold the doors in a closed position.

A safety lock 021 is provided on the body member 005 adjacent the roller 022. The safety lock 021 is configured to selectively restrict rotation of the roller 022. In one embodiment, the safety lock 021 includes a user-actuable mechanism which, when pressed or otherwise engaged, moves into an engaged position in which the roller 022 is prevented from rotating about the roller axis. In a disengaged position of the safety lock 021, the roller 022 is free to rotate so that a caregiver can adjust the protrusion height of the protruding portion of the roller 022 to suit the particular refrigerator door or cabinet door on which the apparatus 100 is installed.

The safety lock 021 is configured so that, when the safety lock 021 is in the engaged position, a child is inhibited from rotating the roller 022. Preventing a child from freely rotating the roller 022 reduces the likelihood that the child will create a gap between the doors sufficient to insert a hand into the refrigerator or cabinet, which could otherwise allow the child to access stored items and could place increased stress on the adhesive connections of the door-contacting surfaces 003 and 004. In some embodiments, the apparatus 100 is installed at a height on the refrigerator door or cabinet door such that an adult caregiver can conveniently operate the safety lock 021 while a young child standing on the floor cannot readily reach or manipulate the safety lock 021.

In certain implementations, the adhesive used at the door-contacting surface 003 and the door-contacting surface 004 is selected to provide resistance to ordinary pulling forces applied by a child while permitting removal or replacement of the apparatus 100 by an adult without damaging the underlying refrigerator or cabinet surfaces. In such implementations, the apparatus 100 not only resists opening of the doors by a child but also provides a visible indication if a child applies excessive force, because damage or displacement of the apparatus 100 alerts a caregiver that the child attempted to open the refrigerator or cabinet.

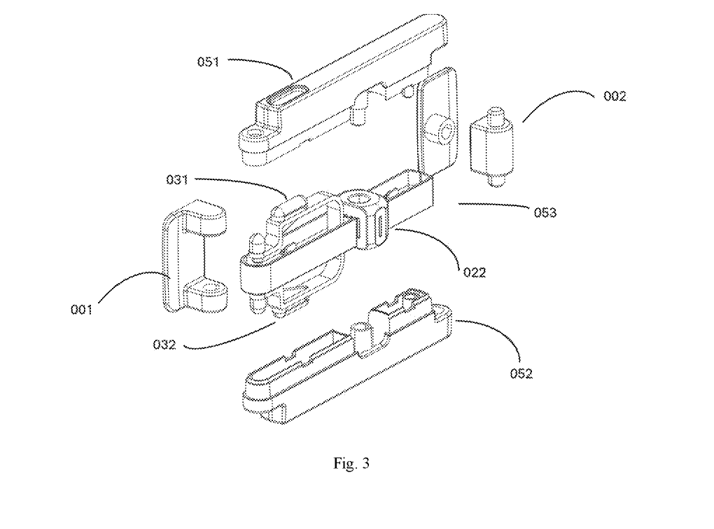

FIG. 3 is an exploded view of the child-proof locking apparatus 100 illustrating internal components of a body member 005 and associated locking mechanisms. In the embodiment depicted, the body member 005 is formed from three cooperating portions, namely an upper body portion 051, a lower body portion 052, and a middle portion 053. In an assembled state, the upper body portion 051, the lower body portion 052, and the middle portion 053 together define the overall body member 005.

The middle portion 053 is configured to house a roller 022 and a safety lock mechanism associated with the safety lock shown as element 021 in FIG. 2. The roller 022 is rotatably supported within the middle portion 053 so as to be rotatable about a roller axis when the body member 005 is assembled. The middle portion 053 further accommodates components of the safety lock mechanism that selectively permit or prevent rotation of the roller 022, as described below.

An upper lock button 031 is positioned adjacent an upper region of the body member 005, and a lower lock button 032 is positioned adjacent a lower region of the body member 005. In the exploded configuration of FIG. 3, the upper body portion 051 is shown above the middle portion 053 and includes an opening or passage through which the upper lock button 031 extends when assembled. Similarly, the lower body portion 052 is shown below the middle portion 053 and includes an opening or passage through which the lower lock button 032 extends when assembled. In the assembled apparatus 100, the upper lock button 031 projects through the opening in the upper body portion 051 and is accessible at an upper side of the body member 005, while the lower lock button 032 projects through the opening in the lower body portion 052 and is accessible at a lower side of the body member 005.

The upper lock button 031 and the lower lock button 032 are mechanically linked to one another so that actuation of either the upper lock button 031 or the lower lock button 032 operates the same safety lock mechanism associated with the safety lock 021 of FIG. 2. In one embodiment, the upper lock button 031 and the lower lock button 032 are coupled to an elongated connector disposed within the middle portion 053, and the connector engages the roller 022 in a manner that restricts or permits rotation of the roller 022. When the upper lock button 031 or the lower lock button 032 is pressed, the connector is displaced to release the roller 022 and allow the roller 022 to rotate. When the upper lock button 031 and the lower lock button 032 are released, the connector returns to an engaged position in which it interferes with rotation of the roller 022 and thereby locks the roller 022 against rotation. In this manner, the upper lock button 031 and the lower lock button 032 together function as the safety lock 021 described with reference to FIG. 2, and a caregiver can lock or unlock the roller 022 by pressing either of the two buttons.

The roller 022 is configured to provide a plurality of discrete protrusion settings relative to the rear face of the body member 005. In one embodiment, the roller 022 has four detent positions corresponding to four different protrusion heights of a protruding portion of the roller 022. By rotating the roller 022 among these four detent positions when the safety lock mechanism is released, a caregiver can select a protrusion height that positions the protruding portion of the roller 022 so that, in use, it bears against a surface of a refrigerator door or cabinet door in combination with the door-contacting surface 003 and the door-contacting surface 004 at the ends of the apparatus 100. When the upper body portion 051, the middle portion 053, and the lower body portion 052 are assembled to form the body member 005, the roller 022 is captured within the middle portion 053 and cooperates with the safety lock mechanism actuated by the upper lock button 031 and the lower lock button 032.

At opposite ends of the body member 005, the first attachment portion 001 and the second attachment portion 002 are coupled to the body member 005 so as to be rotatable in a common plane relative to the body member 005. In one embodiment, the first attachment portion 001 and the second attachment portion 002 are configured such that rotation outwardly away from the body member 005 within this common plane increases an effective length of the apparatus 100 between the door-contacting surface 003 and the door-contacting surface 004, thereby accommodating larger gaps between adjacent door panels. Rotation inwardly toward the body member 005 within the same plane decreases the effective length of the apparatus 100 to accommodate smaller gaps. In a further configuration, the first attachment portion 001 and the second attachment portion 002 may each be rotated approximately 180 degrees toward a user-facing side of the apparatus 100 so that the first attachment portion 001 and the second attachment portion 002 fold over and lie generally overlapping the body member 005. In this folded configuration, the overall length of the apparatus 100 is minimized for storage or for applications where a shorter span between door panels is sufficient.

The adjustability of the roller 022 and the rotatable configuration of the first attachment portion 001 and the second attachment portion 002 together allow the apparatus 100 to be adapted to refrigerator doors, cabinet doors, and other closable elements having different gap dimensions, while the safety lock mechanism actuated by the upper lock button 031 and the lower lock button 032 inhibits a child from freely rotating the roller 022 and creating an undesired opening between the doors.

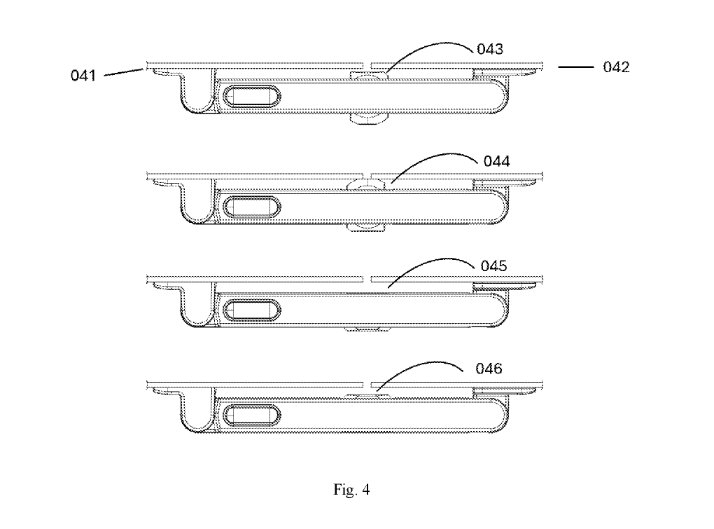

Referring now to FIG. 4, the child-proof locking apparatus 100 is shown installed across a pair of doors of a closable element. A first door panel 041 and a second door panel 042 are illustrated, with a door gap defined between the first door panel 041 and the second door panel 042. The apparatus 100 is mounted so that the body member 005 spans across the door gap between the first door panel 041 and the second door panel 042. The first attachment portion 001 is secured to the first door panel 041 at the door-contacting surface 003, and the second attachment portion 002 is secured to the second door panel 042 at the door-contacting surface 004. In this configuration, the apparatus 100 bridges the door gap between the first door panel 041 and the second door panel 042 rather than being mounted entirely on a single door panel, so that relative opening movement of the two door panels is resisted.

Because the first attachment portion 001 and the second attachment portion 002 each have a finite thickness, the body member 005 is spaced outwardly from the surfaces of the first door panel 041 and the second door panel 042. The roller 022, which is rotatably disposed within the body member 005 as described with reference to FIGS. 2 and 3, is positioned so that its protruding portion aligns with the door gap between the first door panel 041 and the second door panel 042. In use, an adult caregiver selectively rotates the roller 022 among a plurality of discrete settings to adjust the protrusion length of the protruding portion toward the door gap, thereby adapting the apparatus 100 to different gap dimensions while maintaining secure engagement.

In the embodiment illustrated in FIG. 4, different discrete protrusion settings of the roller 022 are represented by reference numerals 043, 044, 045, and 046. A first protrusion configuration 046 corresponds to a relatively retracted position of the protruding portion of the roller 022, in which the protruding portion does not reach the surfaces of the first door panel 041 and the second door panel 042 and therefore does not bear against the door gap. A second protrusion configuration 045 represents another discrete setting of the roller 022, for example a setting corresponding to approximately a “zero” protrusion level, in which the protruding portion remains generally flush with or only slightly beyond the rear face of the body member 005 and likewise does not contact the doors. A third protrusion configuration 043 corresponds to a further extended position of the protruding portion of the roller 022, in which the protrusion extends farther toward the door gap than in configurations 045 and 046 but still does not yet engage the surfaces of the first door panel 041 and the second door panel 042.

A fourth protrusion configuration 044 is shown in FIG. 4 as a condition in which the protruding portion of the roller 022 extends sufficiently toward the door gap to contact the adjacent edge regions of the first door panel 041 and the second door panel 042. In this configuration, the protruding portion of the roller 022 at 044 bears against the door gap with no substantial clearance, and the first attachment portion 001, the second attachment portion 002, and the protruding portion of the roller 022 at 044 are arranged so that their respective contact locations with the doors lie substantially in a common plane. Thus, in the protrusion configuration 044, the door-contacting surface 003 of the first attachment portion 001, the door-contacting surface 004 of the second attachment portion 002, and the protruding portion of the roller 022 at 044 cooperate to press the first door panel 041 and the second door panel 042 toward an adjacent structure and to resist formation of any significant gap at the door gap.

Accordingly, FIG. 4 illustrates how different discrete rotational settings of the roller 022 yield different protrusion configurations 043, 044, 045, and 046 relative to the door gap between the first door panel 041 and the second door panel 042, and how, in at least one configuration 044, the body member 005, the first attachment portion 001, the second attachment portion 002, and the roller 022 together maintain the doors in a closed condition and inhibit opening of the closable element by a child.

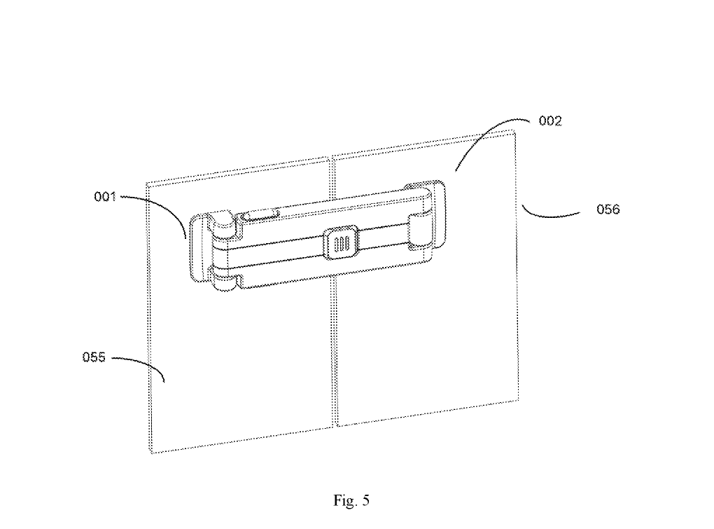

Referring now to FIG. 5, the child-proof locking apparatus 100 is shown installed across a closable element comprising a first door panel 055 and a second door panel 056. The first door panel 055 and the second door panel 056 are adjacent panels of a closable element that, in a closed condition, abut or lie in close proximity to one another along a door gap. The apparatus 100 is mounted so that the first attachment portion 001 is secured to the first door panel 055 and the second attachment portion 002 is secured to the second door panel 056. The door-contacting surface 003 of the first attachment portion 001 contacts the first door panel 055, and the door-contacting surface 004 of the second attachment portion 002 contacts the second door panel 056. In some embodiments, the door-contacting surface 003 is secured to the first door panel 055 and the door-contacting surface 004 is secured to the second door panel 056 by an adhesive, including, without limitation, a strong-bonding adhesive, a double-sided adhesive tape, or a removable adhesive. Because the first attachment portion 001 and the second attachment portion 002 are secured to two separate door panels respectively, the body member 005 bridges the door gap between the first door panel 055 and the second door panel 056 and resists relative opening movement between the two door panels, thereby preventing a child from opening the closable element.

The apparatus 100 is not limited to any particular type of closable element. In one embodiment, the first door panel 055 and the second door panel 056 are the two doors of a double-door refrigerator, and the apparatus 100 is installed at a height that is within reach of an adult caregiver but above the reach of a young child standing on the floor. In another embodiment, the first door panel 055 and the second door panel 056 are the two doors of a kitchen cabinet, such as a cabinet used to store cleaning supplies, sharp utensils, or similar items that present a hazard to a child. In yet another embodiment, the first door panel 055 and the second door panel 056 are the two doors of a bathroom vanity cabinet or a medicine cabinet storing medications or other hazardous substances. In a further embodiment, the first door panel 055 and the second door panel 056 are the two doors of a wardrobe or an armoire in a bedroom. In still another embodiment, the first door panel 055 and the second door panel 056 are the two doors of a bedside cabinet or nightstand. In additional embodiments, the apparatus 100 may be installed on any double-door cabinet, closet, pantry, storage unit, or similar household or commercial enclosure where preventing unauthorized opening by a child is desirable.

1. A child-proof locking apparatus for preventing unauthorized opening of a closable element by a child, the apparatus comprising:
an elongate body member having a user-facing front face and a door-facing rear face;
a first attachment portion pivotably coupled to a first end of the body member and rotatable relative to the body member, the first attachment portion having a door-contacting surface configured to be secured to a surface of the closable element;
a second attachment portion pivotably coupled to a second end of the body member opposite the first end and rotatable relative to the body member, the second attachment portion having a door-contacting surface configured to be secured to the surface of the closable element;
wherein rotation of the first attachment portion and the second attachment portion relative to the body member adjusts an effective length of the apparatus to accommodate closable elements of different dimensions; and
a roller rotatably disposed within the body member and accessible from the front face, the roller being rotatable about a roller axis to selectively advance a protrusion from the rear face of the body member, the protrusion being positionable at a plurality of discrete positions corresponding to different protrusion lengths extending from the rear face toward the surface of the closable element;
wherein, when the apparatus is secured to the closable element, the door-contacting surface of the first attachment portion, the door-contacting surface of the second attachment portion, and a distal end of the protrusion are coplanar and collectively bear against the surface of the closable element at three contact points lying in a common plane, such that the closable element is held flush against an adjacent structure and prevented from opening any gap therebetween.

2. The apparatus of claim 1, wherein each of the first attachment portion and the second attachment portion is rotatable relative to the body member through at least 180 degrees, such that each attachment portion is facing the opposite side of closable element, and selectively increase or decrease the effective length of the apparatus.

3. The apparatus of claim 1, further comprising a safety lock disposed on the body member adjacent the roller, the safety lock being selectively movable between an engaged position in which rotation of the roller about the roller axis is prevented and a disengaged position in which the roller is free to rotate.

4. The apparatus of claim 3, wherein the safety lock comprises an upper lock button accessible at an upper side of the body member and a lower lock button accessible at a lower side of the body member, the upper lock button and the lower lock button being mechanically linked such that actuation of either the upper lock button or the lower lock button operates the safety lock to move the safety lock to the disengaged position.

5. The apparatus of claim 1, wherein the plurality of discrete positions of the roller comprises four detent positions, each detent position corresponding to a different protrusion length of the protrusion extending from the rear face of the body member toward the surface of the closable element.

6. The apparatus of claim 1, wherein the body member comprises an upper body portion, a lower body portion, and a middle portion assembled together, the middle portion housing the roller and a safety lock mechanism, the upper body portion defining a passage through which an upper lock button extends, and the lower body portion defining a passage through which a lower lock button extends.

7. The apparatus of claim 1, wherein the door-contacting surface of the first attachment portion and the door-contacting surface of the second attachment portion are each secured to the surface of the closable element by an adhesive selected from the group consisting of a strong-bonding adhesive, a double-sided adhesive tape, and a removable adhesive.

8. The apparatus of claim 1, wherein the closable element comprises a first door panel and a second door panel defining a door gap therebetween, the first attachment portion being secured to the first door panel and the second attachment portion being secured to the second door panel, such that the body member spans the door gap and resists relative opening movement of the first door panel and the second door panel.

9. The apparatus of claim 1, wherein the body member, the first attachment portion, and the second attachment portion are fabricated from a plastic material, a metallic material, or a combination thereof.

10. The apparatus of claim 1, wherein the apparatus is configured to be mounted on the closable element at a height accessible to an adult caregiver for operating the safety lock while remaining out of reach of a child standing on a floor adjacent the closable element.

11. A method of preventing unauthorized opening of a closable element by a child, the method comprising:
providing a child-proof locking apparatus comprising an elongate body member having a user-facing front face and a door-facing rear face, a first attachment portion pivotably coupled to a first end of the body member, and a second attachment portion pivotably coupled to a second end of the body member opposite the first end, each of the first attachment portion and the second attachment portion having a door-contacting surface, and a roller rotatably disposed within the body member and rotatable about a roller axis to selectively advance a protrusion from the rear face at a plurality of discrete positions;
rotating at least one of the first attachment portion and the second attachment portion relative to the body member to adjust an effective length of the apparatus to correspond to a dimension of the closable element;
securing the door-contacting surface of the first attachment portion and the door-contacting surface of the second attachment portion to a surface of the closable element; and
rotating the roller about the roller axis to advance the protrusion to a selected one of the plurality of discrete positions such that a distal end of the protrusion, the door-contacting surface of the first attachment portion, and the door-contacting surface of the second attachment portion are coplanar and collectively bear against the surface of the closable element at three contact points lying in a common plane, thereby holding the closable element flush against an adjacent structure and preventing the closable element from opening any gap therebetween.

12. The method of claim 11, wherein rotating the at least one of the first attachment portion and the second attachment portion comprises rotating each of the first attachment portion and the second attachment portion through up to 180 degrees relative to the body member, such that each attachment portion faces an opposite side of the closable element, selectively increasing or decreasing the effective length of the apparatus.

13. The method of claim 11, further comprising, after rotating the roller to the selected discrete position, moving a safety lock disposed on the body member adjacent the roller from a disengaged position to an engaged position, thereby preventing further rotation of the roller about the roller axis.

14. The method of claim 13, wherein moving the safety lock to the engaged position comprises releasing an upper lock button accessible at an upper side of the body member and a lower lock button accessible at a lower side of the body member, the upper lock button and the lower lock button being mechanically linked, and wherein moving the safety lock to the disengaged position to permit roller adjustment comprises pressing either the upper lock button or the lower lock button.

15. The method of claim 11, wherein rotating the roller to advance the protrusion to the selected discrete position comprises selecting from four detent positions of the roller, each detent position corresponding to a different protrusion length extending from the rear face of the body member toward the surface of the closable element.

16. The method of claim 11, further comprising assembling the body member from an upper body portion, a lower body portion, and a middle portion prior to securing the apparatus to the closable element, wherein the middle portion houses the roller and a safety lock mechanism, the upper body portion defines a passage through which an upper lock button extends, and the lower body portion defines a passage through which a lower lock button extends.

17. The method of claim 11, wherein securing the door-contacting surface of the first attachment portion and the door-contacting surface of the second attachment portion to the surface of the closable element comprises applying an adhesive selected from the group consisting of a strong-bonding adhesive, a double-sided adhesive tape, and a removable adhesive between each door-contacting surface and the surface of the closable element.

18. The method of claim 11, wherein the closable element comprises a first door panel and a second door panel defining a door gap therebetween, and wherein securing the door-contacting surfaces comprises securing the door-contacting surface of the first attachment portion to the first door panel and securing the door-contacting surface of the second attachment portion to the second door panel, such that the body member spans the door gap and resists relative opening movement of the first door panel and the second door panel.

19. The method of claim 11, further comprising mounting the apparatus on the closable element at a height that is accessible to an adult caregiver for operating the roller and a safety lock while being out of reach of a child standing on a floor adjacent the closable element.

20. The method of claim 11, further comprising, after a period of use, disengaging the door-contacting surface of the first attachment portion and the door-contacting surface of the second attachment portion from the surface of the closable element without damaging the surface of the closable element, and repositioning the apparatus on the closable element at a different location or on a different closable element.
